(19) United States
(12) Patent Application Publication
(10) Pub. No.: US 2026/0302979 A1
(43) Pub. Date: Oct. 1, 2026

(54) ANALYTICAL SECOND ORDER TORQUE HARMONIC REDUCTION IN PMSM DRIVES

(71) Applicant: Steering Solutions IP Holding Corporation, Saginaw, MI (US)

(72) Inventors: Payam Ramezani-Badr, Midland, MI (US); Anik Chowdhury, Auburn Hills, MI (US); Krishna MPK Namburi, Troy, MI (US); Alejandro J. Pina Ortega, Grand Blanc, MI (US)

(21) Appl. No.: 19/555,102

(22) Filed: Mar. 3, 2026

Related U.S. Application Data
(60) Provisional application No. 63/778,750, filed on Mar. 27, 2025.

(51) Int. Cl. H02P 21/05; B62D 5/04; H02P 21/22

(52) U.S. Cl. CPC H02P 21/05; H02P 21/22; B62D 5/046

(57) ABSTRACT

A method for operating a multi-phase permanent magnet synchronous machine (PMSM) includes: determining values of one or more back electromotive force (BEMF) constants of the multi-phase PMSM; determining an initial fundamental current command to cause the multi-phase PMSM to generate an output torque in accordance with a torque command; determining, based on the initial fundamental current command and the values of the one or more BEMF constants, a final current command; and commanding, based on the final current command, an inverter to apply an output voltage to the multi-phase PMSM and thereby causing an output current to be generated in a winding set in accordance with the final current command.

### CROSS REFERENCE TO RELATED APPLICATIONS

This utility patent application claims the benefit of U.S. Provisional Patent Application No. 63/778,750 filed Mar. 27, 2025, the contents of which are incorporated herein by reference in its entirety.

### TECHNICAL FIELD

This disclosure relates to transverse flux electric machines. This disclosure also relates to applications of such transverse flux electric machines in a handwheel actuator of a steering system for a vehicle.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Steer-by-wire (SbW) is a direct evolution of the EPS system where there is no mechanical coupling between the handwheel and the steering rack. An EPS system may include a single actuator with the sole purpose of providing assist to the driver during steering actions. However, on the SbW system, there may be two electric actuators/motors with different functionalities. The electric actuator attached to the rack in a SbW system is called the roadwheel actuator (RWA), whereas the actuator on the driver side is known as the handwheel actuator (HWA). The RWA has the same assist providing function as an EPS system actuator. The HWA on the other hand acts more as a feedback motor rather than providing assist to the driver. In the absence of the HWA the handwheel on a SbW system would just freewheel because of the absence of any mechanical coupling/friction. The HWA, because of its functionality opens a wide array of design related opportunities.

Several different motor architectures are known and which have advantageous properties for given applications. A transverse flux motor (TFM) may be especially well suited for use as a HWA in an EPS system. However, TFMs may produce torque ripple when powered using conventional symmetrical alternating current (AC) currents.

Torque ripple may be mitigated using a lookup table to vary the currents supplied to a motor. However, lookup table-based methods may require end-of-line position-synced torque measurement that may only be feasibly done for one six-sigma part per production design. Thus, any deviation per part will cause non-optimal torque performance.

### SUMMARY

An aspect of the disclosed embodiments includes a method for operating a multi-phase permanent magnet synchronous machine (PMSM). The method includes: determining values of one or more back electromotive force (BEMF) constants of the multi-phase PMSM; determining an initial fundamental current command to cause the multi-phase PMSM to generate an output torque in accordance with a torque command; determining, based on the initial fundamental current command and the values of the one or more BEMF constants, a final current command; and commanding, based on the final current command, an inverter to apply an output voltage to the multi-phase PMSM and thereby causing an output current to be generated in a winding set in accordance with the final current command.

Another aspect of the disclosed embodiments includes a motor control system. The motor control system includes: a multi-phase permanent magnet synchronous machine (PMSM); an inverter configured to supply an alternating current (AC) power to the multi-phase PMSM; and a controller. The controller is configured to: determine an initial fundamental current command to cause the multi-phase PMSM to generate an output torque in accordance with a torque command; load from a machine-readable storage memory, values of a plurality of back electromotive force (BEMF) constants of the multi-phase PMSM; determine, based on the initial fundamental current command and the values of the one or more BEMF constants, a final current command; and command, based on the final current command, the inverter to apply an output voltage to the multi-phase PMSM and thereby causing an output current to be generated in a winding set in accordance with the final current command.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an electric power steering (EPS) system according to the principles of the present disclosure.

FIG. 2 generally illustrates an EPS system according to the principles of the present disclosure.

FIG. 3 generally illustrates a steer-by-wire (SbW) steering system according to the principles of the present disclosure.

FIG. 4 is a schematic diagram of a motor control system according to the principles of the present disclosure.

FIG. 5 is a schematic diagram of a motor controller, according to the principles of the present disclosure.

FIG. 6 shows a cross-sectional diagram of a radial flux machine (RFM) according to the principles of the present disclosure.

FIG. 7 shows a cross-sectional diagram of an axial flux machine (AFM) according to the principles of the present disclosure.

FIG. 8 shows a cross-sectional diagram of a transverse flux machine (TFM) according to the principles of the present disclosure.

FIG. 9 shows a perspective fragmentary view of a TFM with a flux-concentrating outer rotor and a single-piece stator, according to the principles of the present disclosure.

FIG. 10 shows a perspective view of a stator in an external rotor TFM according to the principles of the present disclosure.

FIG. 11 shows a perspective view of a stator in an internal rotor TFM according to the principles of the present disclosure.

FIG. 12 shows a perspective fragmentary view illustrating flux leakage in an internal rotor TFM at an axial end and opposite from the stator, according to the principles of the present disclosure.

FIG. 13 shows a cross-sectional view illustrating flux leakage between stators of different phases in an internal rotor TFM, according to the principles of the present disclosure.

FIG. 14 shows graph illustrating flux linkage imbalance between phases of a three-phase TFM.

FIG. 15 shows a graph illustrating first order harmonics of no-load flux linkages of each phase of a three-phase TFM.

FIG. 16 shows a graph illustrating back electromotive force waveforms for each phase of a three-phase TFM.

FIG. 17 shows a graph illustrating BEMF constants of each phase of a three-phase TFM.

FIG. 18 shows a graph illustrating BEMF constants for each of three line-to-line voltages of a three-phase TFM.

FIG. 19 shows a flow diagram illustrating a method for operating a multi-phase PMSM, according to the principles of the present disclosure

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of the vehicle including providing steering assist to an operator of the vehicle, controlling steerable wheels of the vehicle, and the like.

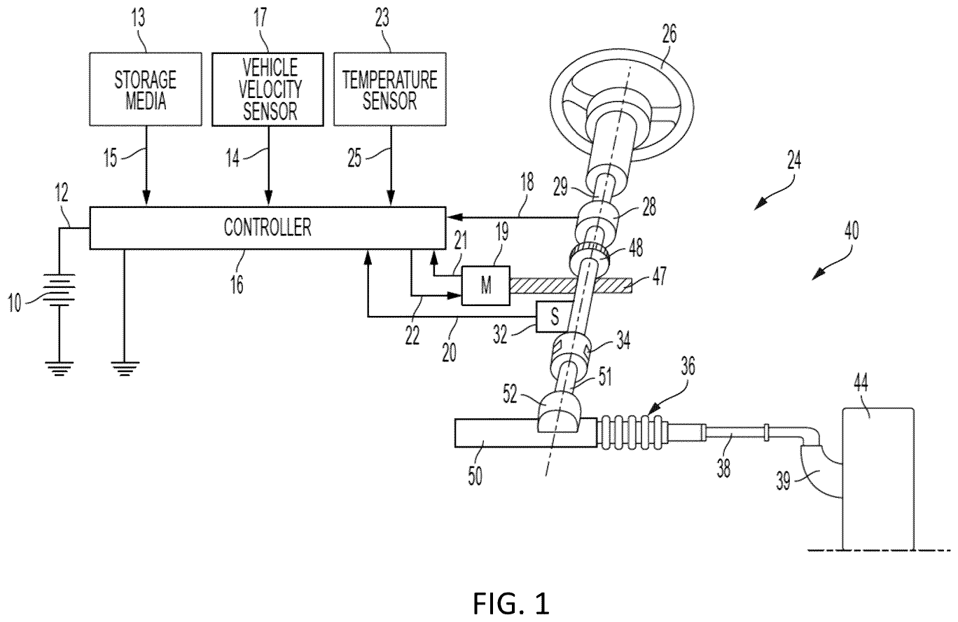

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system generally designated by reference numeral 24 and includes the controller 16 and an electric machine, which could be a permanent magnet synchronous motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time-based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 16 may include input signal processing and filtering to enable accurate sampling and conversion or acquisitions of such signals from communications interfaces.

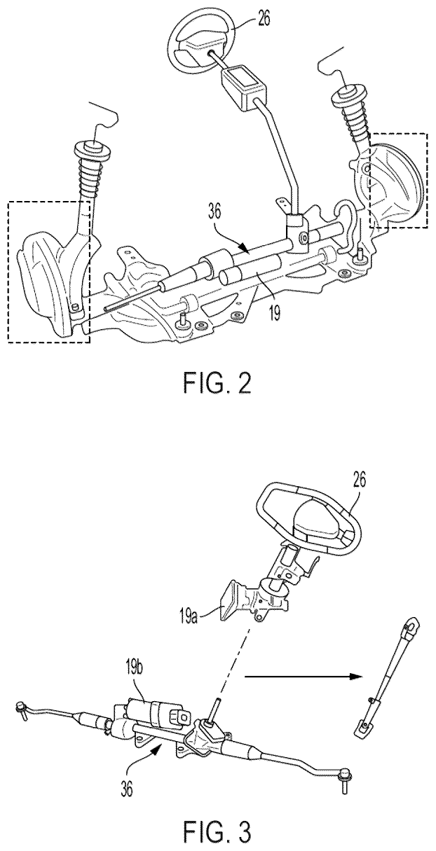

FIG. 2 generally illustrates an EPS system, and FIG. 3 generally illustrates a steer-by-wire (SbW) steering system. The EPS system of FIG. 2 may be similar or identical to the EPS system 40 of FIG. 1, except with the motor 19 mounted directly to the steering mechanism 36. The SbW system of FIG. 3 may be similar or identical to the EPS system 40 of FIG. 1, except without any physical linkage between the steering wheel 26 and the steerable wheels 44, and with two separate and independent motors 19a, 19b. As shown, the SbW system includes a first motor 19a, also called a handwheel actuator (HWA), and a second motor 19b, also called a roadwheel actuator (RWA). The HWA 19a is configured to provide a torque to the steering wheel 26 for providing haptic feedback to a driver.

SbW is a direct evolution of the EPS system where there is no mechanical coupling between the steering wheel 26 and the steering rack. As seen in FIG. 2, an EPS system may include a single actuator 19 with the sole purpose of providing assist to the driver during steering actions. However, on the SbW system, there are two electric actuators/motors with different functionalities. The electric actuator attached to the steering mechanism 36 in a SbW system is called the roadwheel actuator (RWA) 19b, whereas the actuator on the driver side is known as the handwheel actuator (HWA) 19a. The RWA 19b may provide the same assist function as the actuator 19 in an EPS system. The HWA 19a, on the other hand, acts more as a feedback motor rather than providing assist to the driver. In the absence of the HWA 19a the handwheel on a SbW system would just freewheel because of the absence of any mechanical coupling/friction. The HWA 19a, because of its' functionality, opens a wide array of design-related opportunities.

As used herein, variables with a tilde (~) above the variable symbol represent an estimation, which may be determined by a mathematical calculation, a lookup table, etc. Variables with a bar above the variable symbol represent a vector quantity. Variables with a superscript star (*) represent commands or desired set point values.

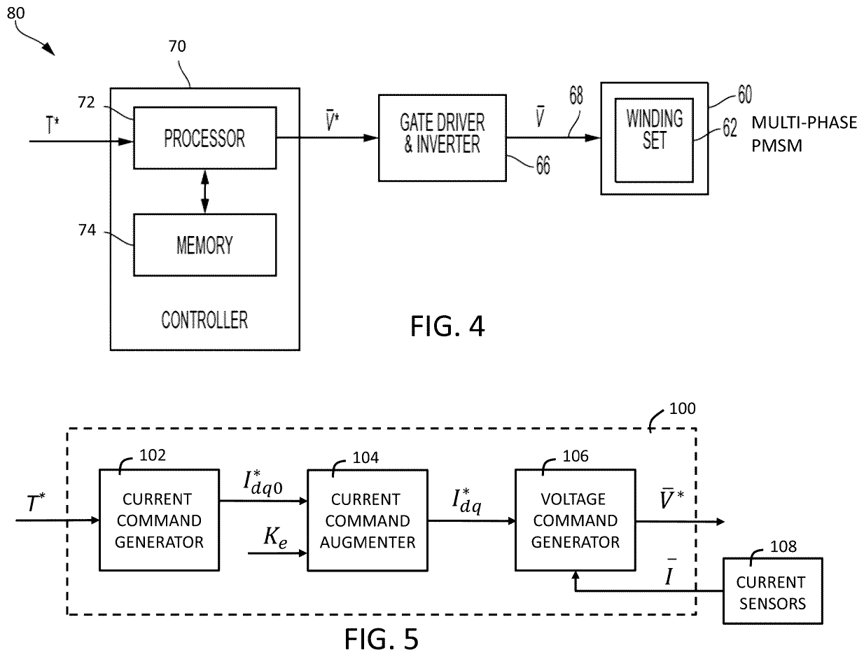

FIG. 4 illustrates an electric motor control system 80 having a multi-phase permanent magnet synchronous machine (PMSM) 60, a power converter 66 (including a gate driver and a corresponding inverter), and a controller 70, which may also be called an electronic control unit (ECU). The multi-phase PMSM 60 may be a transverse flux machine (TFM). However, the multi-phase PMSM 60 may have a different configuration, such as a radial flux machine (RFM) or an axial flux machine (AFM) topology. The PMSM 60 may be used in any number of applications, such as for the motor 19 in the steering motion control system 24 shown in FIG. 1. The power converter 66 may include several switching devices, such as field effect transistors (FETs) for switching high current loads and gate driver circuitry for operating the switching devices. The controller 70 may receive a motor torque command T* from an external source, such as, for example, a power steering controller. Alternatively, the controller 70 may include hardware and/or software to compute the motor torque command T* to cause the multi-phase PMSM 60 to generate a corresponding torque for performing some given task, such as actuating the steering.

The multi-phase PMSM 60 includes a winding set 62. The multi-phase PMSM 60 is capable of generating electromagnetic torque by energizing the winding set 62. The winding set 62 may include three phases and thus may include three phase windings. Alternatively, the winding set 62 may include any number of winding phases, such as five or seven phases. The power converter 66 is configured to supply alternating current (AC) voltages to the winding set 62. The winding set 62 is connected to the power converter 66 through the phase leads 68.

The controller 70 generates a voltage command V̅*, which may include d-axis and q-axis constituent parts,

$${V}_{d}^{*} , {V}_{q}^{*} ,$$

respectively, based on the motor torque command T*. The controller 70 may include any suitable controller. The controller 70 may be configured to control, for example, various functions of the vehicle systems described herein. The controller 70 may include a processor 72 and a memory 74. The processor 72 may include any suitable processor, such as those described herein. Additionally, or alternatively, the controller 70 may include any suitable number of processors, in addition to or other than the processor 72. The memory 74 may comprise a single disk or a plurality of disks (e.g., hard drives), and includes a storage management module that manages one or more partitions within the memory 74. In some embodiments, memory 74 may include flash memory, semiconductor (solid state) memory or the like. The memory 74 may include Random Access Memory (RAM), a Read-Only Memory (ROM), or a combination thereof. The memory 74 may include instructions that, when executed by the processor 72, cause the processor 72 to, at least, control various functions of the steering system and/or any other suitable function, including those of the systems and methods described herein.

FIG. 5 is a schematic diagram of a motor controller 100 that is configured to generate the command V̅* based on the motor torque command T*. The motor controller 100 may be implemented using hardware and/or software. In some embodiments, the motor controller 100 may be implemented by software instructions running on the processor 72. The motor controller 100 includes a current command generator 102 that computes or otherwise generates an initial fundamental current command

$${I}_{dq 0}^{*}$$

based on the motor torque command T*. The current command generator 102 may use any technique, such as conventional functions that utilize maximum torque per-ampere and/or maximum torque per-voltage methods, in order to generate the initial fundamental current command

$${I}_{dq 0}^{*}$$

to cause the multi-phase PMSM 60 to generate an output torque in accordance with the motor torque command T*.

The motor controller 100 also includes a current command augmenter 104 that computes or otherwise generates a final current command

$${I}_{dq}^{*}$$

based on the initial fundamental current command

$${I}_{dq 0}^{*}$$

and based on values or one or more BEMF constants Kₑ. Operation in accordance with the final current command

$${I}_{dq}^{*}$$

may cause the cause the multi-phase PMSM 60 to have advantageous results, such as reduction in torque ripple, that may otherwise result from asymmetries in flux linkages of the multi-phase PMSM 60.

The motor controller 100 also includes a voltage command generator 106 that computes or otherwise generates the voltage command V̅* based on the final current command

$${I}_{dq}^{*} .$$

The voltage command generator 106 may use a feedforward technique that determines the voltage command V̅* based solely on the final current command

$${I}_{dq}^{*} .$$

Alternatively or additionally, the voltage command generator 106 may use a feedback technique that determines the voltage command V̅* based on the final current command

$${I}_{dq}^{*}$$

and based on a measured current signal Ī from one or more current sensors 108.

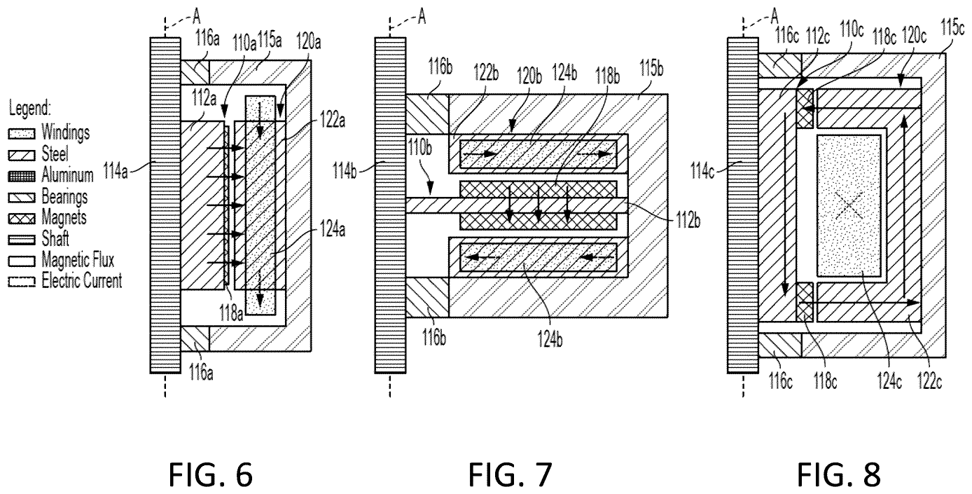

FIG. 6 shows a cross-sectional diagram of a radial flux machine (RFM). FIG. 7 shows a cross-sectional diagram of an axial flux machine (AFM). FIG. 8 shows a cross-sectional diagram of a transverse flux machine (TFM). Each of the RFM, AFM, and TFM devices includes a shaft configured to rotate about an axis A. Classification between the RFM, AFM, and TFM configurations may be made based on direction of magnetic flux.

The RFM of FIG. 6 includes a first rotor 110a having a first rotor core 112a attached to rotate with a first shaft 114a about an axis A. The first rotor 110a is located within a first housing 115a and the first shaft 114a extends through and out of the first housing 115a and is supported by a pair of first bearings 116a. A set of first permanent magnets 118a is attached to the first rotor core 112a and produces a magnetic flux that extends radially outwardly. The RFM of FIG. 6 also includes a first stator 120a having a first stator core 122a with a set of first windings 124a extending therethrough and carrying electric current in an axial direction, parallel to the axis A, and perpendicular to the magnetic flux.

The AFM of FIG. 7 includes a second rotor 110b having a second rotor core 112b attached to rotate with a second shaft 114b about an axis A. The second rotor 110b is located within a second housing 115b and the second shaft 114b extends through and out of the second housing 115b and is supported by a pair of second bearings 116b. A set of second permanent magnets 118b is attached to the second rotor core 112b and produces a magnetic flux that extends in an axial direction, parallel to the axis A. The AFM of FIG. 7 also includes a second stator 120b having a second stator core 122b with a set of second windings 124b extending therethrough and carrying electric current in a radial direction, perpendicular to the axis A, and perpendicular to the magnetic flux.

The TFM of FIG. 8 includes a third rotor 110c having a third rotor core 112c attached to rotate with a third shaft 114c about an axis A. The third rotor 110c is located within a third housing 115c and the third shaft 114c extends through and out of the third housing 115c and is supported by a pair of third bearings 116c. A set of third permanent magnets 118c is attached to the third rotor core 112c and produces a magnetic flux that extends radially inwardly at a first location, axially through the third rotor core 112c, and radially outwardly at a second location spaced apart axially apart from the first location. The TFM of FIG. 8 also includes a third stator 120c having a third stator core 122c with a set of third windings 124c extending therethrough and carrying electric current in a circumferential direction, perpendicular to the axis A, and perpendicular to the magnetic flux. As shown, the third stator core 122c defines a U-shape, with open ends aligned with the third permanent magnets 118c at the first and second locations for providing, with the third rotor core 112c, a closed rectangular path of the magnetic flux.

FIGS. 6-8 show the flux direction in the three machine topologies. For the RFM, the flux moves radially in the airgap, whereas for the AFM the flux moves axially from the stator to rotor and vice versa. However, as seen in FIG. 8 for the TFM, the flux moves both in the radial and the axial directions. Even though several topologies of TFM can be identified from the literature, 3D (radial and axial) flux paths are a common feature across different topologies. TFMs are known for their higher volumetric and gravimetric power densities compared to radial flux machines. AFMs and TFMs are known to have comparable power densities. However, the simplicity of the ring windings in a TFM has the potential to ease manufacturing process and save cost.

As shown in FIG. 6, the magnetic flux in the RFM extends primarily in a radial direction, perpendicularly to the axis A. As shown in FIG. 7, the magnetic flux in the AFM extends primarily in an axial direction, parallel to the axis A. As shown in FIG. 8 the magnetic flux in the TFM defines a closed loop path, with portions extending in a radial direction, perpendicularly to the axis A, and with other portions extending in an axial direction, parallel to the axis A. The RFM, AFM, and TFM configurations may each provide different volumetric and gravimetric power densities. The TFM configuration may be especially well suited for low speed and high torque operation.

The present disclosure provides a Transverse flux machine (TFM) topology for a direct drive SbW HWA architecture. Transverse flux machines have the potential to provide significant power density advantages over the traditional radial flux machines in the low-speed high torque region of operation of a direct drive SbW HWA. Traditional RFMs can be laminated in the radial X-Y plane to accommodate their 2D flux paths and reduce eddy current losses at high frequencies of operation. AFMs can be laminated as well in the axial X-Z plane to assist the axial travel of the flux from the stator to rotor and vice versa. However, as seen in FIG. 8 for a TFM the flux moves in both radial and axial direction. If a TFM were to be laminated, it would need to have both X-Y and X-Z direction laminations depending on the core location and intended direction of flux travel. This would severely complicate the manufacturing process of the TFM. In order to avoid complications and ensure 3D flux travel in the TFM cores, soft magnetic core (SMC) material is chosen here. SMC is insulated iron particles compacted into the shape of the cores. Electrical insulation among the iron particles of a compacted SMC core significantly reduces the eddy current loss at higher frequencies of operation. The conclusions drawn in this document are equally applicable to a TFM made of laminated steel.

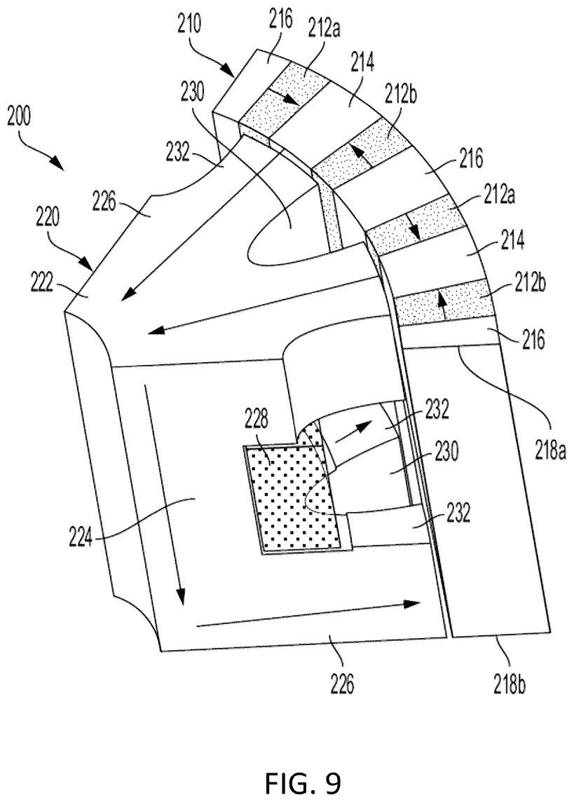

As shown, FIG. 9 presents a first TFM 200 having an external rotor configuration, with a first rotor 210 that is configured to rotate about an axis, with the rotor extending annularly about an internal stator assembly 220. FIG. 9 shows a 45-degree segment of the first TFM 200, with labels indicating magnetic flux. However, the complete first TFM 200 would include eight of such segments. The first rotor 210 includes a plurality of pairs of first permanent magnets 212a, 212b arranged at regular angular intervals and configured to produce magnetic flux in a circumferential direction therebetween. The first rotor 210 also includes a plurality of first flux concentrating cores 214 located between the first permanent magnets 212a, 212b of each of the pairs of first permanent magnets 212a, 212b and configured to conduct the magnetic flux therebetween. The first rotor 210 also includes a plurality of first flux diverging cores 216, each located between adjacent pairs of the first permanent magnets 212a, 212b. The first rotor 210 has a tubular shape and extends between a first axial end 218a and a second axial end 218b.

As also shown in FIG. 9, the internal stator assembly 220 includes an internal stator core 222 having a U-shaped cross-section with an inner cylindrical portion 224 and a pair of arms 226 extending radially outwardly from each end of the inner cylindrical portion 224 and toward the first rotor 210. A winding 228 extends in circumferential direction through the center of the U-shaped cross-section of the internal stator core 222 and conducts electrical current in the circumferential direction.

As shown, each arm 226 of the internal stator core 222 includes an arc-shaped recess 230 to define two radial-extending protrusions 232 that are angularly spaced apart to align with adjacent ones of the first flux concentrating cores 214 and the first flux diverging cores 216. In this way, magnetic flux is conducted from each of the first flux concentrating cores 214 adjacent the first axial end 218, across an airgap and into the radial-extending protrusions 232 of the internal stator core 222 adjacent thereto. The magnetic flux is directed into the inner cylindrical portion 224 of the internal stator core 222 where it continues in an axial direction. The magnetic flux is also directed out of the inner cylindrical portion 224 of the internal stator core 222 and radially outwardly through the arms 226 of the internal stator core 222 adjacent to the second axial end 218b, where it crosses the airgap into a corresponding one of the first flux diverging cores 216. The magnetic flux continues through corresponding ones of the first permanent magnets 212a, 212b and then back into the first flux concentrating cores 214, thereby completing a closed path.

A TFM may be particularly well suited for direct drive low speed operation. The TFM may include a modular, spatially shifted three-phase stator architecture. The TFM may include a simple ring winding with inner stator topology. The TFM may provide a relatively low phase resistance, independent of number of stator slots and rotor poles. The TFM may include an outer rotor structure with high volumetric and gravimetric torque density. The TFM may be relatively easily and efficiently manufactured and may provide suitable performance for a variety of applications in an EPS and/or SbW system.

The phase resistance and the coil cross-section in a ring wound TFM are independent of the number of poles which enables higher torque density in TFMs compared to RFMs. Moreover, for some applications, such as a direct drive HWA in a SbW system, the operating speed is relatively low. This indicates that the fundamental electrical frequency of operation will be within a reasonable range, even if a higher pole number TFM is chosen. For example, for a 12 slot 8 pole SbW HWA with a gear ratio of 11:1, the fundamental frequency is 166.67 Hz at 2500 motor rpm. On the other hand, for a TFM with 100 poles and a direct drive structure, the fundamental frequency is 189.39 Hz at 227.27 motor rpm. The limiting number of poles (Pmax) for a TFM can be calculated using equation (1):

$${n}_{limit} = 120 \frac{{f}_{e , max}}{{P}_{max}} \qquad ( 1 )$$

where nₗᵢₘᵢₜ is the maximum motor speed in rpm, f_{e,max} is the maximum fundamental electrical frequency that can be handled by the motor drive.

Moreover, despite higher number of poles in TFMs the phase resistance does not increase which can offer reduced copper loss and thus improve efficiency and thermal performance.

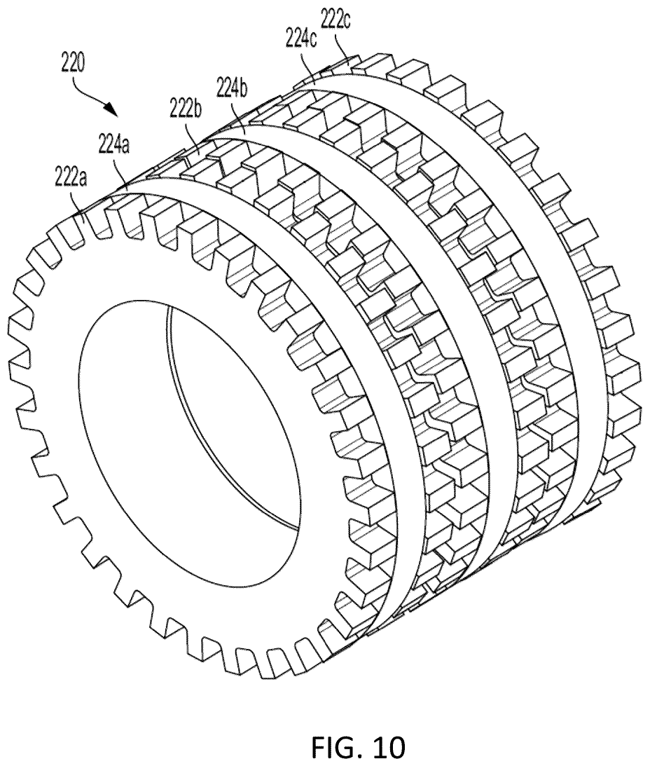

FIG. 10 shows a perspective view of the internal stator assembly 220 for an external rotor TFM, which is configured to have the rotor (not shown) disposed annularly thereabout. The internal stator assembly 220 includes three internal stator cores 222a, 222b, 222c, including an A-phase internal stator core 222a, a B-phase internal stator core 222b, and a C-phase internal stator core 222c. The three internal stator cores 222a, 222b, 222c each have similar or identical ring shapes that are stacked axially and shifted circumferentially from one-another. Each of the three internal stator cores 222a, 222b, 222c of the internal stator assembly 220 contains a corresponding winding 224a, 224b, 224c of a corresponding phase, and which extends circumferentially therethrough. Each of the three internal stator cores 222a, 222b, 222c of the internal stator assembly 220 also defines a plurality of radial-extending protrusions at regular angular intervals and extending radially outwardly.

The stacked assembly of the TFM stator leads to inherent asymmetry issues. As shown in FIG. 10, the B-phase internal stator core 222b is stacked between the A-phase internal stator core 222a and the C-phase internal stator core 222c in a 3-phase TFM. The A-phase internal stator core 222a and the C-phase internal stator core 222c may each be called exterior cores because of their location adjacent to an axial end of the stator assembly. The B-phase internal stator core 222b may be called an interior stator core, because of its location spaced apart from the axial end of the stator assembly.

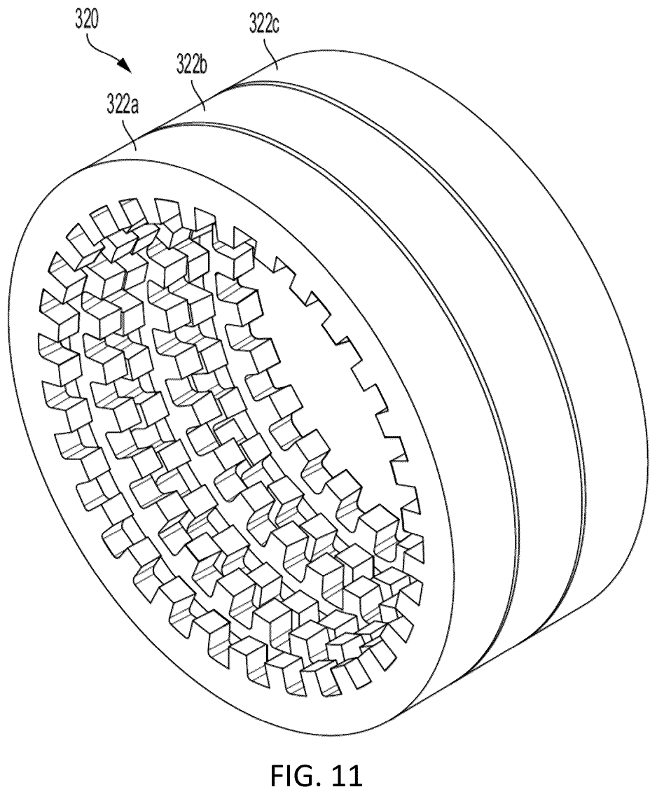

FIG. 11 shows a perspective view of an external stator assembly 320 for an internal rotor TFM, which is configured to be disposed annularly about a rotor (not shown). external stator assembly 320 includes three external stator cores 322a, 322b, 322c, including an A-phase external stator core 322a, a B-phase external stator core 322b, and a C-phase external stator core 322c. The three external stator cores 322a, 322b, 322c each have similar or identical ring shapes that are stacked axially and shifted circumferentially from one-another. Each of the three external stator cores 322a, 322b, 322c of the external stator assembly 320 may contain a corresponding winding (not shown in FIG. 11) of a corresponding phase, and extending circumferentially therethrough. Each of the three external stator cores 322a, 322b, 322c of the external stator assembly 320 also defines a plurality of radial-extending protrusions at regular angular intervals and extending radially inwardly.

Several different factors may affect the design of a TFM. Such design factors may include: topology selection and manufacturing challenges; material selection; number of poles; Inner/Outer rotor (i.e. internal rotor or external rotor configuration); multiphysics performance; and 3-dimensional (3D) simulations, which may be computationally expensive.

### Flux Leakage

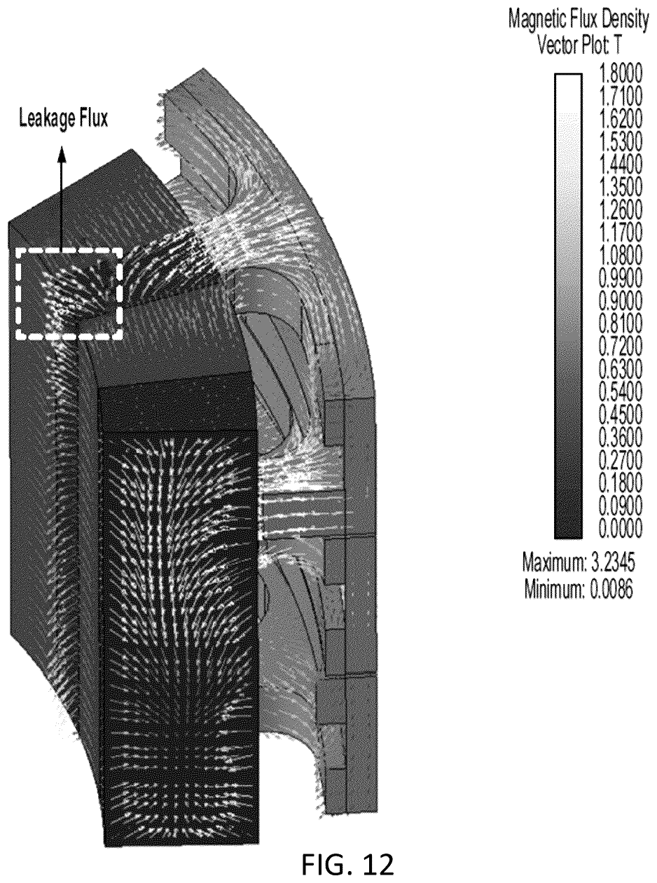

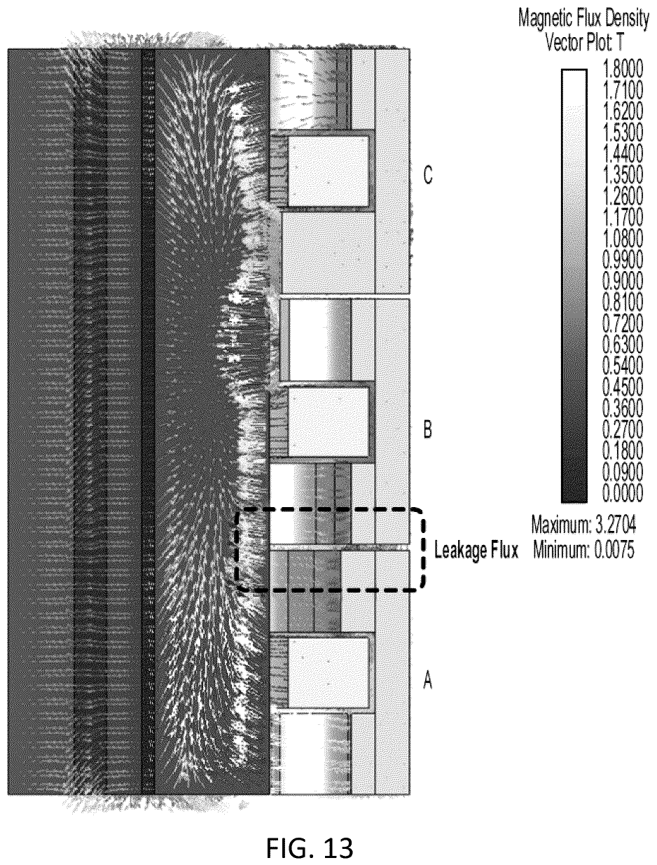

Despite their several benefits, TFMs suffer from flux leakage issues because of the complex 3D nature of their flux paths. The amount of flux leakage may vary from one topology to another. Moreover, flux leakage is highly dependent on the number of poles in the TFM. FIGS. 12-13 show examples of the leakages happening in a TFM rotor and stacked stator structure. These leakages if left untreated will increase the magnet material weight in the optimized machine and thus will increase cost.

Transverse flux machines have built in leakage issues because of the 3D nature of the flux path. Rotor leakages present on the flux concentrating core opposite the airgap (i.e. opposite from the stator), as shown in FIG. 12. Stator-to-stator leakages may be present in a modular stator architecture, as shown in FIG. 13. A modular stator structure with ring-shaped windings may give rise to asymmetric electromagnetic behavior among the stators of a multi-phase machine, such as a three-phase machine.

Continuing to refer to FIG. 13, Phase B is between Phase A and Phase C. However, for the Phase A and Phase C, one side of the stator has air rather than ferromagnetic material. As a result, fluxes are leaking through the air instead of going inside the ferromagnetic material as shown in FIG. 12.

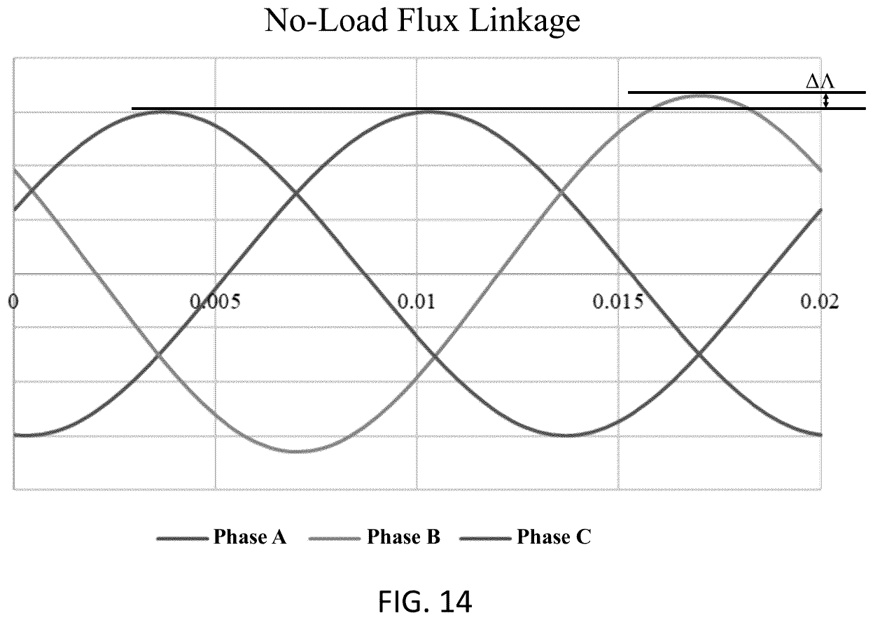

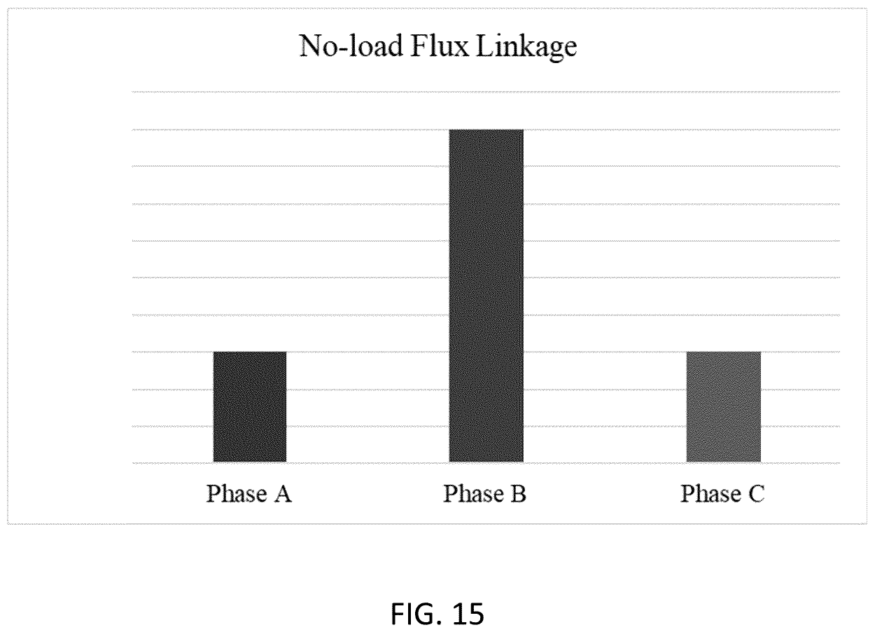

As shown in FIG. 14, peak value of the no-load flux linkages are the not the same for the different phases. Phase B has more flux linkage compared to the Phase A and Phase C. As shown, the A-phase and C-phase each have similar flux linkage values, and B-phase has a flux linkage that is greater than the flux linkages of the A-phase and the C-phase by a flux leakage difference AA. Also, and as shown in FIG. 15, first order harmonics of the no-load flux linkage are also not equal. This asymmetry in the flux linkages generate second order torque ripple harmonics in the machine.

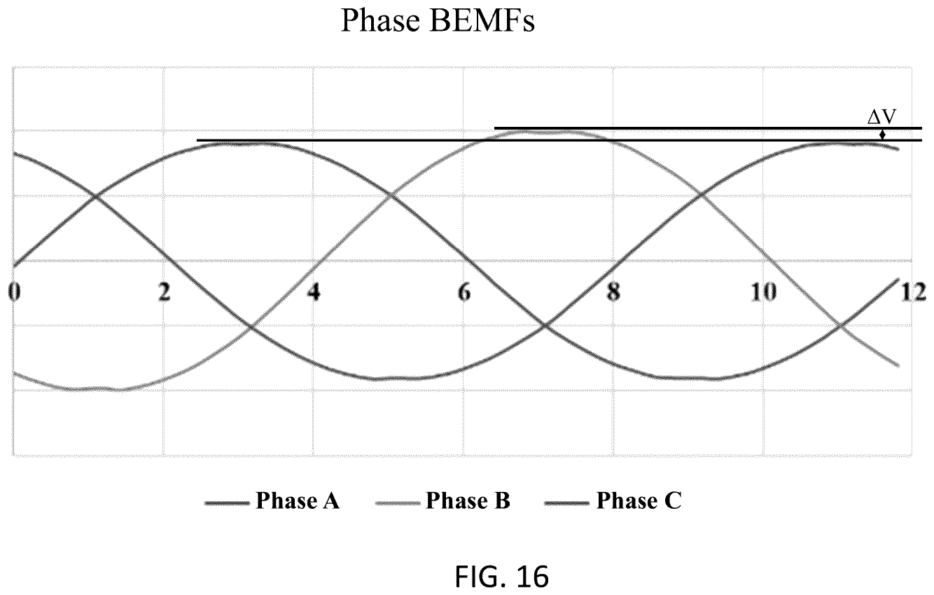

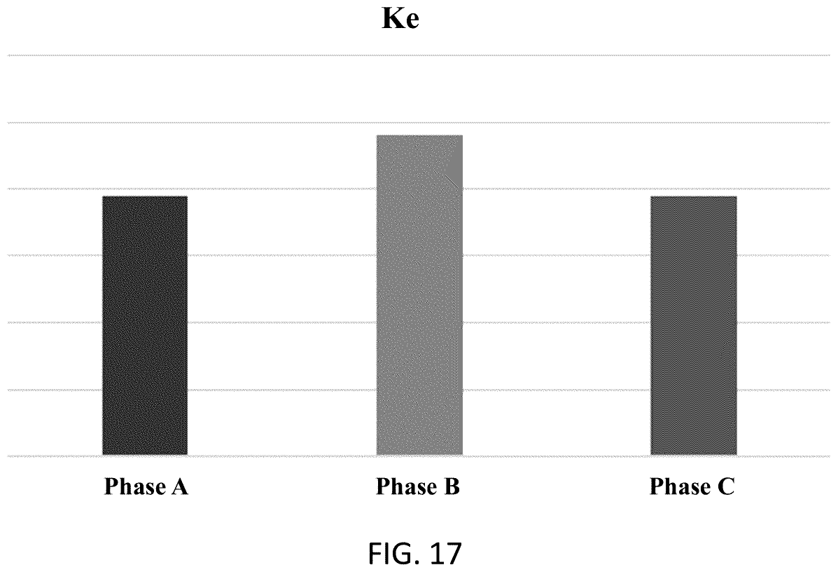

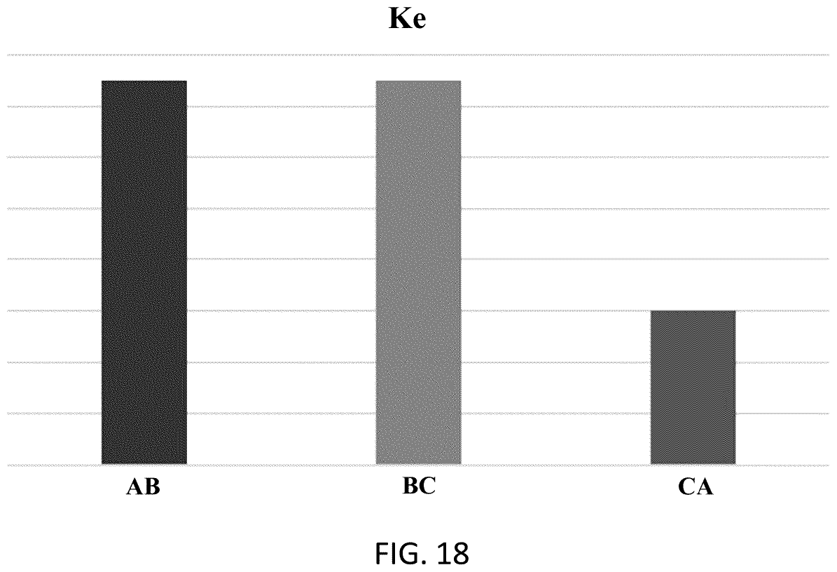

Due to the unbalanced no-load flux linkage in the phases, the BEMF waveforms of the phases are also unbalanced which makes the BEMF constant Kₑ unequal for each of the phases shown in FIG. 17. As shown in FIG. 16, the A-phase and C-phase each have similar peak value of BEMF values, and the B-phase has a peak value BEMF that is greater than the BEMF values of the A-phase and the C-phase by a voltage difference ΔV. The values of the BEMF constants Kₑ for different phases is shown in FIG. 17, where the imbalance in the BEMF constants Kₑ is observed. Similarly, an imbalance in line-to-line BEMF constants Kₑ is also as shown in FIG. 18.

Torque ripple may be mitigated using a lookup table to vary the currents supplied to a motor. However, lookup table-based methods may require end-of-line position-synced torque measurement that may only be feasibly done for one qualified part per production design. Thus, any deviation per part can cause non-optimal torque performance. However, back-emf (BEMF) open circuit tests may be standard for each part coming off the assembly line. The differences in BEMF constants Kₑ discrepancy issue shown in FIGS. 15-17 for TFM designs can be quantified via BEMF tests. The present disclosure provides a method of torque ripple cancellation aims to utilize information from BEMF to provide not only effective and targeted ripple mitigation, but such that it is simple to implement.

The fundamental flux linkages induced by the permanent magnets into the motor windings are described in equations (3)-(5).

$${λ}_{a} = {Λ}_{a} cos ( {θ}_{e} ) \qquad ( 3 )$$

$${λ}_{b} = {Λ}_{b} cos ( {θ}_{e} - \frac{2 π}{3} + {ϕ}_{b} ) \qquad ( 4 )$$

$${λ}_{c} = {Λ}_{c} cos ( {θ}_{e} + \frac{2 π}{3} + {ϕ}_{c} ) \qquad ( 5 )$$

Where Λₐ, Λ_{b}, Λ_{c} are magnetic flux linkage magnitudes, θₑ is the electrical rotor position, and φ_{b} and φ_{c} are the phase shift terms that account for any phase asymmetries in flux linkages. In TFMs, unlike regular PMSMs, the magnetic flux linkage magnitudes are not equal (Λₐ≠Λ_{b}≠Λ_{c}), and sometimes phase shift offsets are non-zero as well (φ_{b}, φ_{c}≠0). Considering these conditions, the Park and Clark transformations convert magnetic flux linkages of equations (3)-(5) into dq synchronous reference frame variables as described in equation (6), below.

$$[ \begin{matrix}{λ}_{d} \\ {λ}_{q}\end{matrix} ] = \frac{2}{3} [ \begin{matrix}cos ( {θ}_{e} ) & cos ( {θ}_{e} - \frac{2 π}{3} ) & cos ( {θ}_{e} + \frac{2 π}{3} ) \\ s in ( {θ}_{e} ) & sin ( {θ}_{e} - \frac{2 π}{3} ) & sin ( {θ}_{e} + \frac{2 π}{3} )\end{matrix} ] [ \begin{matrix}{λ}_{a} \\ {λ}_{b} \\ {λ}_{c}\end{matrix} ] \qquad ( 6 )$$

Using trigonometric identities, equation (6) may be decomposed to two components as follows.

$${λ}_{d} = {λ}_{d 0} + {λ}_{d 2} \qquad ( 7 )$$

$${λ}_{q} = {λ}_{q 0} + {λ}_{q 2} \qquad ( 8 )$$

The expressions in equations (7)-(8) are organized into constants (λ_{dg0}) and second harmonic terms (λ_{dg2}), which would help distinguishing their contributions to output electromagnetic torque. The electromagnetic torque (Tₑ) equation and the synchronous reference frame “total” flux linkages (ψ_{dq}) equations for a PMSM with Nₚ magnetic poles is described in equations (9)-(10), whereas equations (7)-(8) are substituted in to derive the fundamental and second harmonic torque contributions.

$${T}_{e} = \frac{3}{2} \frac{{N}_{p}}{2} ( {ψ}_{d} {I}_{q} - {ψ}_{q} {I}_{d} ) \qquad ( 9 )$$

$${T}_{e} = \frac{3}{2} \frac{{N}_{p}}{2} [ {\underbrace{( {λ}_{d 0} + {λ}_{d 2} ) {I}_{q} - ( {λ}_{q 0} + {λ}_{q 2} ) {I}_{d}}}_{magnetic torque} + {\underbrace{( {L}_{d} - {L}_{q} ) {I}_{d} {I}_{q}}}_{reluctance torque} ] \qquad ( 10 )$$

With a goal of designing a control law with a second harmonic q-axis current command component

$$( {I}_{q 2}^{*} )$$

that compensates for and thereby eliminates the second harmonic electromagnetic torque:

$${I}_{q}^{*} = {I}_{q 0}^{*} + {I}_{q 2}^{*} cos ( 2 {θ}_{e} + {δ}_{q 2} ) \qquad ( 11 )$$

$${I}_{d}^{*} = {I}_{d 0}^{*} \qquad ( 12 )$$

where

$${I}_{q 0}^{*}$$

is a fundamental value or d-axis current command

$${I}_{d 0}^{*}$$

is a fundamental value of d-axis current command,

$${I}_{q}^{*}$$

is the final q-axis current command,

$${I}_{d}^{*}$$

is a final d-axis current command, θₑ is an electrical angular position, and δ_{q2} is a phase shift angle of the second harmonic q-axis current command component

$${I}_{q 2}^{*} ,$$

and L_{d}, L_{q} are the motor synchronous inductances.

Substituting equations (11)-(12) in equations (9)-(10), and solving for

$${T}_{e 2}^{*} = 0 ,$$

provides:

$${T}_{e}^{*} = \frac{3}{2} \frac{{N}_{p}}{2} [ {\underbrace{{λ}_{d 0} {I}_{q 0}^{*} - {λ}_{q 0} {I}_{d 0}^{*} + ( {L}_{d} - {L}_{q} ) {I}_{d 0}^{*} {I}_{q 0}^{*}}}_{{T}_{e 0}^{*}} + {\underbrace{\begin{matrix}{λ}_{d 0} {I}_{q 2}^{*} cos ( 2 {θ}_{e} + {δ}_{q 2} ) + {λ}_{d 2} {I}_{q 0}^{*} - \\ {λ}_{q 2} {I}_{d 0}^{*} + ( {L}_{d} - {L}_{q} ) {I}_{d 0}^{*} {I}_{q 2}^{*} cos ( 2 {θ}_{e} + {δ}_{q 2} )\end{matrix}}}_{{T}_{e 2}^{*}} + {\underbrace{{λ}_{d 2} {I}_{q 2}^{*} cos ( 2 {θ}_{e} + {δ}_{q 2} )}}_{{T}_{e 4}^{*}} ] \qquad ( 13 )$$

$${I}_{q 2}^{*} cos ( 2 {θ}_{e} + {δ}_{q 2} ) = - \frac{{λ}_{d 2}}{{λ}_{d 0} + ( {L}_{d} - {L}_{q} ) {I}_{d 0}^{*}} {I}_{q 0}^{*} + \frac{{λ}_{q 2}}{{λ}_{d 0} + ( {L}_{d} - {L}_{q} ) {I}_{d 0}^{*}} {I}_{d 0}^{*} \qquad ( 14 )$$

where

$${T}_{e}^{*}$$

is a torque command, Nₚ is a number of poles of the motor, λ_{d0} is the d-axis flux linkage constant, λ_{q0} is the q-axis flux linkage constant, λ_{d2} is a second harmonic d-axis flux linkage, λ_{q2} is a second harmonic q-axis flux linkage,

$${T}_{e 0}^{*}$$

is a zero-frequency (0^{th} harmonic) torque command,

$${T}_{e 2}^{*}$$

is a second harmonic torque command, and

$${T}_{e 4}^{*}$$

is a fourth harmonic torque command, and L_{d}, L_{q} are the d-axis and q-axis motor synchronous inductances, respectively.

The initial fundamental current command

$${I}_{dq 0}^{*} ,$$

which includes fundamental value of d-axis and q-axis current commands

$${I}_{d 0}^{*} , {I}_{q 0}^{*} ,$$

may be calculated utilizing any technique, such as conventional functions that utilize maximum torque per-ampere and/or maximum torque per-voltage methods. The initial fundamental current command

$${I}_{dq 0}^{*}$$

may then be used alongside the flux linkage ratios

$$\frac{{λ}_{d 2}}{{λ}_{d 0} + ( {L}_{d} - {L}_{q} ) {I}_{d 0}^{*}} , \frac{{λ}_{q 2}}{{λ}_{d 0} + ( {L}_{d} - {L}_{q} ) {I}_{d 0}^{*}}$$

to calculate the second harmonic q-axis current command. Thus, the final q-axis motor current command

$${I}_{q}^{*}$$

after reordering of some variables is derived such that:

$${I}_{q}^{*} = {I}_{q 0}^{*} - \frac{1}{{λ}_{d 0} + ( {L}_{d} - {L}_{q} ) {I}_{d 0}^{*}} ( {λ}_{d 2} {I}_{q 0}^{*} - {λ}_{q 2} {I}_{d 0}^{*} ) \qquad ( 15 )$$

All the calibration data needed to compute the final q-axis current command

$${I}_{q}^{*}$$

using equation (15) can be extracted from standard open-circuit voltage test and short circuit current test by calculating BEMF constants Kₑ for each line and synchronous inductances L_{dq}. Note that BEMF constants Kₑ represent flux linkage magnitudes λₓ and the number of magnetic pole pairs in the motor. Therefore, the equations (3)-(15) can be alternatively derived using line-line Kₑ measurements in the proposed method. A −30-degree phase lead may be introduced from line-line to phase vector conversion. Additionally, any phase asymmetries (φ) can also be quantified from BEMF test procedures and included in calibrations for maximum torque ripple cancellation efficacy.

The present disclosure provides a novel system and method for operating a TFM with torque ripple compensation. More specifically, the present disclosure provides an extended mathematical expression of magnetic flux linkages considering the unique characteristics of TFM-type PMSMs, resulting in their asymmetric distribution in the synchronous reference frame. The present disclosure also provides an innovative analytical approach to compute optimal commutation current commands for TFM-type PMSMs and other motors that suffer from asymmetric magnet flux distribution in the windings.

The system and method of the present disclosure has clear advantages to alternative look-up-table-based approaches, since it can be calibrated with simple open-circuit BEMF tests, which may be done for each part in production and as part of existing quality control testing, instead of once per design; thus, offering better performance tuned to the part. The system and method of the present disclosure may also take less calibration process time then look-up-table-based methods.

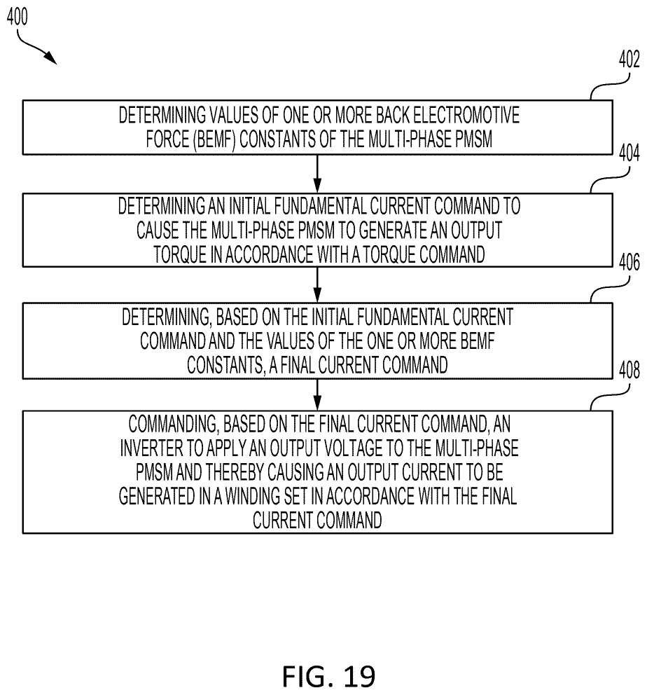

FIG. 19 shows a flow diagram illustrating a method 400 for operating a multi-phase permanent magnet synchronous machine (PMSM), according to the principles of the present disclosure. The method 400 has demonstrated advantages in mitigating second harmonic electromagnetic torque ripple in transverse flux machine (TFM) type multi-phase PMSMs. The method 400 may provide similar advantageous results with other types of PMSM, such as a radial flux machine (RFM) or an axial flux machine (AFM) topology. One or more steps of the method 400 can be performed by the controller 70, in accordance with some embodiments of the present disclosure. As can be appreciated in light of the disclosure, the order of operation within the method is not limited to the sequential execution as illustrated in FIG. 19, but may be performed in one or more varying orders as applicable and in accordance with the present disclosure.

The method 400 includes determining values of one or more back electromotive force (BEMF) constants of the multi-phase TFM at step 402. For example, the BEMF constants for a given TFM may be determined by testing the TFM using an open circuit test that may be performed during an end-of-line testing as part of a manufacturing process. Alternatively, the BEMF constants may be determined based on a standardized design of the TFM or at a later time, such as after the TFM is integrated into a larger assembly, such as during testing of an assembled drive unit or an assembled vehicle. The one or more BEMF constants may include BEMF constants for each of a plurality of phases of the multi-phase TFM. Alternatively, the one or more BEMF constants may include BEMF constants for less than all of the phases of the multi-phase TFM, such as a BEMF constant of the B-phase that is in a center position in a multi-phase TFM with the internal stator assembly 220 shown in FIG. 10 or a TFM with the external stator assembly 320.

In some embodiments, the values of the one or more BEMF constants may be performed on a part-by-part basis for each of a plurality of instances of the multi-phase TFM. In some embodiments, step 402 may include determining the values of the one or more BEMF constants by performing a BEMF open circuit test of the multi-phase TFM. In some embodiments, step 402 may include determining the values of the one or more BEMF constants is performed during an end-of-line test during manufacturing of the multi-phase TFM or an assembly that includes the multi-phase TFM.

In some embodiments, each BEMF constant of the one or more BEMF constants may represent a corresponding phase of the multi-phase TFM. For example, the BEMF constants Kₑ may be determined for each of A, B, and C phases of the TFM, as shown and described with reference to FIG. 16. Alternatively, each BEMF constant of the one or more BEMF constants may represent a corresponding line-to-line wiring arrangement of the multi-phase TFM. For example, the BEMF constants Kₑ may be determined for each of an AB wiring connection, a BC wiring connection, and a CA wiring connection, each representing a wiring arrangement between two of the phase leads 68, as shown and described with reference to FIG. 17.

The method 400 also includes determining an initial fundamental current command to cause the multi-phase TFM to generate an output torque in accordance with a torque command at step 404. For example, the processor 72 may execute instructions to calculate the initial fundamental current command

$${I}_{d q 0}^{*}$$

based on the torque command

$${T}_{e}^{*}$$

utilizing a maximum torque per-ampere and/or a maximum torque per-voltage method.

The method 400 also includes determining, based on the initial fundamental current command and the values of the one or more BEMF constants, a final current command at step 406. For example, the processor 72 may execute instructions to implement the current command augmenter 104 in order to calculate or otherwise determine the final current command

$${I}_{d q}^{*}$$

based on the initial fundamental current command

$${I}_{d q 0}^{*}$$

and based on values of the BEMF constants Kₑ.

The method 400 also includes commanding, based on the final current command, an inverter to apply an output voltage to the multi-phase TFM and thereby causing an output current to be generated in a winding set in accordance with the final current command at step 408. For example, the processor 72 may execute instructions to implement the voltage command generator 106 in order to calculate or otherwise determine the voltage command V̅* based on the final current command

$${I}_{d q}^{*} .$$

Step 408 may further include communicating the voltage command V̅* from the controller 70 and to the power converter 66, thereby causing the inverter of the power converter 66 to apply the output voltage V̅ to the multi-phase TFM 60, and thereby causing an output current Ī to be generated in the winding set 62.

The present disclosure provides a method for operating a multi-phase permanent magnet synchronous machine (PMSM). The method includes: determining values of one or more back electromotive force (BEMF) constants of the multi-phase PMSM; determining an initial fundamental current command to cause the multi-phase PMSM to generate an output torque in accordance with a torque command; determining, based on the initial fundamental current command and the values of the one or more BEMF constants, a final current command; and commanding, based on the final current command, an inverter to apply an output voltage to the multi-phase PMSM and thereby causing an output current to be generated in a winding set in accordance with the final current command.

In some embodiments, each BEMF constant of the one or more BEMF constants represents a corresponding phase of the multi-phase PMSM.

In some embodiments, each BEMF constant of the one or more BEMF constants represents a corresponding line-to-line wiring arrangement of the multi-phase PMSM.

In some embodiments, determining the values of the one or more BEMF constants is performed on a part-by-part basis for each of a plurality of instances of the multi-phase PMSM.

In some embodiments, determining the values of the one or more BEMF constants includes performing a BEMF open circuit test of the multi-phase PMSM.

In some embodiments, determining the values of the one or more BEMF constants is performed during an end-of-line test during manufacturing of the multi-phase PMSM or an assembly that includes the multi-phase PMSM.

In some embodiments, the final current command includes a final q-axis current command, and determining the final current command further includes calculating the final q-axis current command to compensate for a second harmonic electromagnetic torque ripple resulting from differences in flux linkage between two or more phases of the multi-phase PMSM.

In some embodiments, calculating the final q-axis current command includes calculating the final q-axis current command

$$( {I}_{q}^{*} )$$

in accordance with:

$${I}_{q}^{*} = {I}_{q 0}^{*} - \frac{1}{{λ}_{d 0} + ( {L}_{d} - {L}_{q} ) {I}_{d 0}^{*}} ( {λ}_{d 2} {I}_{q 0}^{*} - {λ}_{q 2} {I}_{d 0}^{*} ) ,$$

where λ_{d0} is a d-axis flux linkage constant, λ_{d2} is a second harmonic d-axis flux linkage,

$${I}_{q 0}^{*}$$

is a q-axis component of the initial fundamental current command, λ_{q2} is a second harmonic q-axis flux linkage,

$${I}_{d 0}^{*}$$

is a d-axis component of the initial fundamental current command, and L_{d}, L_{q} are the motor synchronous inductances.

In some embodiments, the multi-phase PMSM includes plurality of stator cores each having a ring shape, and the plurality of stator cores are stacked axially and shifted circumferentially from one-another.

In some embodiments, the multi-phase PMSM has an internal rotor configuration with a stator extending annularly about a rotor.

In some embodiments, the multi-phase PMSM has an external rotor configuration with a rotor extending annularly about a stator.

The present disclosure also provides a motor control system. The motor control system includes: a multi-phase permanent magnet synchronous machine (PMSM); an inverter configured to supply an alternating current (AC) power to the multi-phase PMSM; and a controller. The controller is configured to: determine an initial fundamental current command to cause the multi-phase PMSM to generate an output torque in accordance with a torque command; load from a machine-readable storage memory, values of a plurality of back electromotive force (BEMF) constants of the multi-phase PMSM; determine, based on the initial fundamental current command and the values of the one or more BEMF constants, a final current command; and command, based on the final current command, the inverter to apply an output voltage to the multi-phase PMSM and thereby causing an output current to be generated in a winding set in accordance with the final current command.

In some embodiments, each BEMF constant of the one or more BEMF constants represents a corresponding phase of the multi-phase PMSM.

In some embodiments, each BEMF constant of the one or more BEMF constants represents a corresponding line-to-line wiring arrangement of the multi-phase PMSM.

In some embodiments, determining the values of the one or more BEMF constants is performed on a part-by-part basis for each of a plurality of instances of the multi-phase PMSM.

In some embodiments, determining the values of the one or more BEMF constants includes performing a BEMF open circuit test of the multi-phase PMSM.

In some embodiments, determining the values of the one or more BEMF constants is performed during an end-of-line test during manufacturing of the multi-phase PMSM or an assembly that includes the multi-phase PMSM.

In some embodiments, the final current command includes a final q-axis current command, and determining the final current command further includes calculating the final q-axis current command to compensate for a second harmonic electromagnetic torque ripple resulting from differences in flux linkage between two or more phases of the multi-phase PMSM.

In some embodiments, the controller is configured to calculate the final q-axis current command

$$( {I}_{q}^{*} )$$

in accordance with:

$${I}_{q}^{*} = {I}_{q 0}^{*} - \frac{1}{{λ}_{d 0} + ( {L}_{d} - {L}_{q} ) {I}_{d 0}^{*}} ( {λ}_{d 2} {I}_{q 0}^{*} - {λ}_{q 2} {I}_{d 0}^{*} ) ,$$

where λ_{d0} is a d-axis flux linkage constant, λ_{d2} is a second harmonic d-axis flux linkage,

$${I}_{q 0}^{*}$$

is a q-axis component of the initial fundamental current command, λ_{q2} is a second harmonic q-axis flux linkage,

$${I}_{d 0}^{*}$$

is a d-axis component of the initial fundamental current command, and L_{d}, L_{q} are the motor synchronous inductances.

In some embodiments, the multi-phase PMSM includes plurality of stator cores each having a ring shape, and the plurality of stator cores are stacked axially and shifted circumferentially from one-another.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for operating a multi-phase permanent magnet synchronous machine (PMSM), comprising:
determining values of one or more back electromotive force (BEMF) constants of the multi-phase PMSM;
determining an initial fundamental current command to cause the multi-phase PMSM to generate an output torque in accordance with a torque command;
determining, based on the initial fundamental current command and the values of the one or more BEMF constants, a final current command; and
commanding, based on the final current command, an inverter to apply an output voltage to the multi-phase PMSM and thereby causing an output current to be generated in a winding set in accordance with the final current command.

2. The method of claim 1, wherein each BEMF constant of the one or more BEMF constants represents a corresponding phase of the multi-phase PMSM.

3. The method of claim 1, wherein each BEMF constant of the one or more BEMF constants represents a corresponding line-to-line wiring arrangement of the multi-phase PMSM.

4. The method of claim 1, wherein determining the values of the one or more BEMF constants is performed on a part-by-part basis for each of a plurality of instances of the multi-phase PMSM.

5. The method of claim 1, wherein determining the values of the one or more BEMF constants includes performing a BEMF open circuit test of the multi-phase PMSM.

6. The method of claim 1, wherein determining the values of the one or more BEMF constants is performed during an end-of-line test during manufacturing of the multi-phase PMSM or an assembly that includes the multi-phase PMSM.

7. The method of claim 1, wherein the final current command includes a final q-axis current command, and
wherein determining the final current command further includes calculating the final q-axis current command to compensate for a second harmonic electromagnetic torque ripple resulting from differences in flux linkage between two or more phases of the multi-phase PMSM.

8. The method of claim 7, wherein calculating the final q-axis current command includes calculating the final q-axis current command
$$( {I}_{q}^{*} )$$
in accordance with:
$${I}_{q}^{*} = {I}_{q 0}^{*} - \frac{1}{{λ}_{d 0} + ( {L}_{d} - {L}_{q} ) {I}_{d 0}^{*}} ( {λ}_{d 2} {I}_{q 0}^{*} - {λ}_{q 2} {I}_{d 0}^{*} ) ,$$
where λ_{d0} is a d-axis flux linkage constant, λ_{d2} is a second harmonic d-axis flux linkage,
$${I}_{q 0}^{*}$$
is a q-axis component of the initial fundamental current command, λ_{q2} is a second harmonic q-axis flux linkage,
$${I}_{d 0}^{*}$$
is a d-axis component of the initial fundamental current command, and L_{d}, L_{q} are the motor synchronous inductances.

9. The method of claim 1, wherein the multi-phase PMSM includes plurality of stator cores each having a ring shape, and wherein the plurality of stator cores are stacked axially and shifted circumferentially from one-another.

10. The method of claim 1, wherein the multi-phase PMSM has an internal rotor configuration with a stator extending annularly about a rotor.

11. The method of claim 1, wherein the multi-phase PMSM has an external rotor configuration with a rotor extending annularly about a stator.

12. A motor control system, comprising:
a multi-phase permanent magnet synchronous machine (PMSM);
an inverter configured to supply an alternating current (AC) power to the multi-phase PMSM; and
a controller configured to:
determine an initial fundamental current command to cause the multi-phase PMSM to generate an output torque in accordance with a torque command;
load from a machine-readable storage memory, values of a plurality of back electromotive force (BEMF) constants of the multi-phase PMSM;
determine, based on the initial fundamental current command and the values of the one or more BEMF constants, a final current command; and
command, based on the final current command, the inverter to apply an output voltage to the multi-phase PMSM and thereby causing an output current to be generated in a winding set in accordance with the final current command.

13. The motor control system of claim 12, wherein each BEMF constant of the one or more BEMF constants represents a corresponding phase of the multi-phase PMSM.

14. The motor control system of claim 12, wherein each BEMF constant of the one or more BEMF constants represents a corresponding line-to-line wiring arrangement of the multi-phase PMSM.

15. The motor control system of claim 12, wherein determining the values of the one or more BEMF constants is performed on a part-by-part basis for each of a plurality of instances of the multi-phase PMSM.

16. The motor control system of claim 12, wherein determining the values of the one or more BEMF constants includes performing a BEMF open circuit test of the multi-phase PMSM.

17. The motor control system of claim 12, wherein determining the values of the one or more BEMF constants is performed during an end-of-line test during manufacturing of the multi-phase PMSM or an assembly that includes the multi-phase PMSM.

18. The motor control system of claim 12, wherein the final current command includes a final q-axis current command, and wherein determining the final current command further includes calculating the final q-axis current command to compensate for a second harmonic electromagnetic torque ripple resulting from differences in flux linkage between two or more phases of the multi-phase PMSM.

19. The motor control system of claim 18, wherein the controller is configured to calculate the final q-axis current command
$$( {I}_{q}^{*} )$$
in accordance with:
$${I}_{q}^{*} = {I}_{q 0}^{*} - \frac{1}{{λ}_{d 0} + ( {L}_{d} - {L}_{q} ) {I}_{d 0}^{*}} ( {λ}_{d 2} {I}_{q 0}^{*} - {λ}_{q 2} {I}_{d 0}^{*} ) ,$$
where λ_{d0} is a d-axis flux linkage constant, λ_{d2} is a second harmonic d-axis flux linkage,
$${I}_{q 0}^{*}$$
is a q-axis component of the initial fundamental current command, λ_{q2} is a second harmonic q-axis flux linkage,
$${I}_{d 0}^{*}$$
is a d-axis component of the initial fundamental current command, and L_{d}, L_{q} are the motor synchronous inductances.

20. The motor control system of claim 12, wherein the multi-phase PMSM includes plurality of stator cores each having a ring shape, and wherein the plurality of stator cores are stacked axially and shifted circumferentially from one-another.
